(19) United States
(12) Patent Application Publication
(10) Pub. No.: US 2026/0238729 A1
(43) Pub. Date: Aug. 13, 2026

(54) INFORMATION PROCESSING SYSTEM, METHOD, AND COMPUTER-READABLE STORAGE MEDIUM STORING PROGRAM

(71) Applicant: CANON KABUSHIKI KAISHA, Tokyo (JP)

(72) Inventor: MAYATO SAKAGUCHI, Kanagawa (JP)

(21) Appl. No.: 19/532,422

(22) Filed: Feb. 6, 2026

(30) Foreign Application Priority Data
Feb. 12, 2025 (JP) 2025-020989

(51) Int. Cl. H04N 1/00

(52) U.S. Cl. CPC H04N 1/00633; H04N 1/00771

(57) ABSTRACT

An information processing system includes at least one memory and at least one processor that are configured to receive event information related to an event that has occurred in a printing apparatus and output notification information for issuing a notification of the event that has occurred in the printing apparatus, based on the event information. If the event information includes change information indicating a change of a discharge destination of printouts printed by the printing apparatus, the notification information includes discharge destination information indicating the discharge destination after the change.

### BACKGROUND

### Field of the Technology

The present disclosure relates to an information processing system, a method, and a computer-readable storage medium storing a program.

### Description of the Related Art

Some printing apparatuses have a function of changing a discharge destination of printouts when the discharge destination becomes full. When a discharge tray becomes full, the discharge destination is changed from this discharge tray to another discharge tray, thereby preventing job interruptions and improving work efficiency. Japanese Patent Laid-Open No. 2011-128199 discloses an image forming apparatus with which a time when a discharge section becomes full or a time when the discharge destination switches to another discharge section can be known in advance.

### SUMMARY

Embodiments of the present disclosure improve user convenience when the discharge destination of printouts is changed.

The present disclosure in one aspect provides an information processing system comprising at least one memory and at least one processor. The at least one memory and the at least one processor are configured to receive event information related to an event that has occurred in a printing apparatus and output notification information for issuing a notification of the event that has occurred in the printing apparatus, based on the event information. If the event information includes change information indicating a change of a discharge destination of printouts printed by the printing apparatus, the notification information includes discharge destination information indicating the discharge destination after the change.

According to the present disclosure, it is possible to provide a technology that improves user convenience when the discharge destination of printouts is changed.

Features of various embodiments will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 shows an example configuration of a notification system.

FIGS. 2A and 2B show an example configuration of each device.

FIGS. 3A and 3B show an example configuration of a printer.

FIG. 4 shows an example software configuration of a service server.

FIG. 5 shows an example of a notification screen of a client terminal.

FIGS. 6A and 6B show examples of screens of a service application.

FIG. 7 is a sequence diagram illustrating notification processing.

FIG. 8 shows an example of a screen of the service application.

FIGS. 9A to 9C are diagrams illustrating identifiers and names of discharge destinations.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Conventionally, when the discharge destination is automatically changed during printing, a user can visually check the discharge destination in the printing apparatus to determine to which discharge destination printouts have been discharged. However, depending on the printing apparatus, the number of discharge destinations of printouts may vary, or many discharge destinations may be provided. Moreover, more than one printing apparatus may be managed collectively. In such a case, it may be difficult for the user to visually ascertain the discharge destination. Therefore, there is a demand for a technology for improving user convenience when the discharge destination of printouts is changed.

### First Embodiment

A printing system includes a printer. As will be described later, the printer has a discharge device for discharging printouts. The discharge device includes a plurality of discharge trays. Furthermore, a plurality of discharge devices may be connected to the printer. That is, the printing system may have a plurality of discharge destinations of printouts. In such a printing system, when the discharge destination of printouts is automatically switched while the printer is printing, it is sometimes difficult for the user to visually ascertain the discharge destination to which printouts of each print job have been discharged. There are also cases where the discharge destinations of printouts can be ascertained from printing history of the printer. However, when the printing system includes more than one printer, it may take time and effort to check the discharge destination of printouts. Therefore, there is a demand for a technology for improving user convenience such that the user can easily ascertain the discharge destination of printouts when the discharge destination of printouts is changed.

In the present embodiment, when a printer having a plurality of discharge destinations changes the discharge destination of printouts, an information processing apparatus, such as a server, generates information indicating the changed discharge destination. The information processing apparatus then transmits the generated information to a client terminal. Such processing performed by the information processing apparatus allows the user to easily ascertain the discharge destination of printouts from the client terminal when the printer changes the discharge destination of printouts.

### System configuration

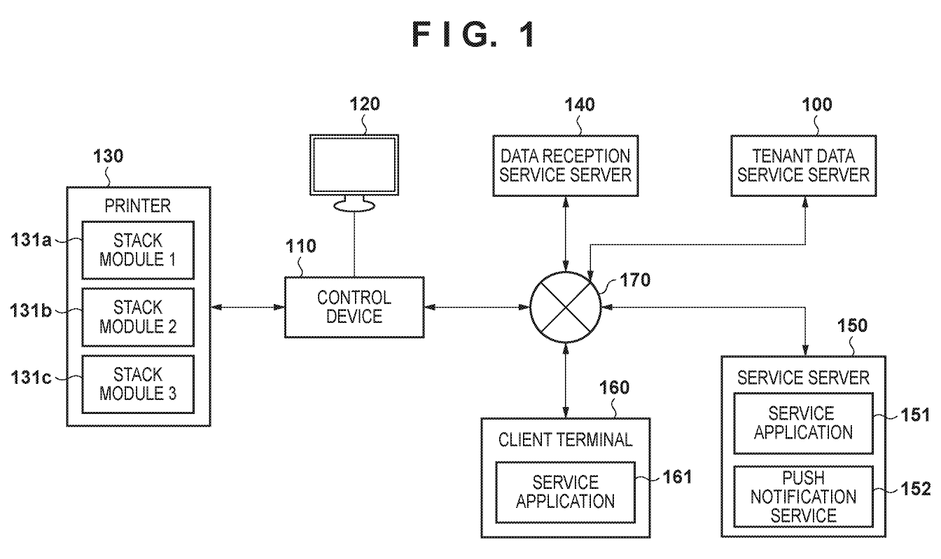

FIG. 1 shows an example of a configuration of a notification system according to the present embodiment. The notification system includes a printing system and a server system. The printing system includes a printer 130 and a control device 110. The printer 130 is connected to the control device 110 and can communicate with the control device 110. A monitor 120 is connected to the control device 110. The control device 110 is connected to a network 170 via a wireless Local Area Network (LAN), a wired LAN, or the like. The printer 130 is connected to the network 170 via the control device 110. Note that the present embodiment uses an example in which the control device 110 is provided outside the printer 130, but the present disclosure is not limited to this. For example, the printer 130 and the control device 110 may be integrated. Although FIG. 1 shows an example in which the printing system includes one printer 130, the printing system may include more than one printer 130.

The server system includes a tenant data service server 100, a data reception service server 140, and a service server 150. The servers included in the server system are connected to the network 170 via a wireless LAN, a wired LAN, or the like, and can communicate with each other via the network 170. Each server can communicate with external devices, such as the printing system and the client terminal 160, via the network 170. Note that the server system in the present embodiment includes a plurality of servers, but the present disclosure is not limited to this. The server system may be constituted by integrating a plurality of servers shown in FIG. 1.

The notification system uses the server system to notify the client terminal 160 of information regarding the printer included in the printing system. The printer information is information regarding the printer 130. The printer information includes, for example, information regarding the state of the printer 130, information indicating various events that have occurred in the printer 130, and information indicating configurations of devices included in the printer 130. In the following description, information regarding various events that have occurred in the printer 130 may be referred to as “event information”. Note that examples of events that occur in the printer 130 will be described later.

The printing system periodically transmits printer information to the service system. The server system generates necessary information according to the content of the received printer information, and the server system transmits the generated information to the client terminal 160. The client terminal 160 transmits a request for the printer information to the service server 150. The client terminal 160 displays the received printer information on a display section 215, which will be described later.

The above-described notification system notifies the client terminal 160 of various types of information regarding the printer 130, thereby allowing the client (user) to monitor the state of the printer 130, events that have occurred in the printer 130, and the like from a remote location. That is, the notification system may also be referred to as a remote monitoring system for remotely monitoring the printer 130.

The printer 130 is a printing apparatus with a printing function. For example, the printer 130 prints an image on a print medium, such as paper, film, or a sheet, based on a print job received from the control device 110. The printer 130 is, for example, an electrophotographic laser printer. Note that the printing method of the printer 130 is not limited to an electrophotographic method, and the printing method may also be an inkjet method. The printer 130 may be a color printer or a monochrome printer. Further, the printer 130 may be a multifunctional peripheral (MFP) that integrates functions such as scanner and facsimile functions, in addition to the printing function.

The printer 130 includes stack modules 131a to 131c. The stack modules 131a to 131c are discharge devices that discharge a print medium on which an image has been printed by the printer 130, to the outside of the printer 130. A “print medium on which an image has been printed by a printing section 305” can be rephrased as a printout. The stack modules 131a to 131c are, for example, joined to the printing section 305, which will be described later. That is, the stack modules 131a to 131c can be rephrased as discharge devices connected to the main body of the printer 130. The stack modules 131a to 131c each have a discharge tray (discharge section) for discharging a printout printed by the printer 130. For example, the stack modules 131a to 131c may each have a plurality of discharge trays, such as a discharge tray for stacking printouts on a carriage and a discharge tray installed at an upper portion of the main body. The printer 130 discharges printouts to a discharge destination designated by the print job.

The stack module 131a is connected to a rear portion of the printer 130. The stack module 131b is connected to a rear portion of the stack module 131a. The stack module 131c is connected to a rear portion of the stack module 131b.

The printer 130 in the present embodiment includes three stack modules 131a to 131c, but the number of stack modules included in the printer 130 is not limited to this. The printer 130 may have one stack module. Also, second and subsequent stack modules may be optionally connectable to the printer 130.

The printer 130 has a function of automatically changing the discharge destination from a current one to a different one to discharge printouts, in accordance with the state of the discharge destination. Hereinafter, this function may also be referred to as a “discharge destination change function”. The discharge destination change function can be rephrased as a discharge destination switching function. For example, the discharge tray of the stack module 131a may be filled with printouts while the printer 130 is executing a print job. In such a case, if printouts can be discharged to the discharge tray of the stack module 131b, the printer 130 changes the discharge destination from the stack module 131a to the stack module 131b and continues to execute the print job.

The control device 110 is, for example, an information processing apparatus such as a personal computer (PC). Note that the control device 110 may be another information processing apparatus such as a smartphone, a tablet terminal, or a server device. The control device 110 is communicably connected to the printer 130 via a communication network, such as an intranet. The control device 110 manages print instructions to the printer 130. The control device 110 manages the print instructions in the form of print jobs. A print job contains information for designating the discharge destination of printouts.

When the control device 110 receives printer information from the printer 130, the control device 110 transmits the received printer information to the data reception service server 140. As described above, the printer information includes event information, information indicating the apparatus configuration of the printer 130, and the like. In the printer 130, various events occur, such as a start of printing, a completion of printing, errors (e.g., paper jams and running out of consumables), the number of printouts discharged to the discharge tray reaching a maximum number, a change of the discharge destination, and a decrease in the remaining amount of consumables. The consumables may include printing materials, such as toner and ink, and print media, such as paper and film. When an event occurs in the printer 130, the printer 130 transmits printer information including event information corresponding to the occurring event to the control device 110.

The monitor 120 is a display device that is connected to the control device 110 and displays various user interface screens (UI screens).

The tenant data service server 100, the data reception service server 140, and the service server 150 are, for example, information processing apparatuses, specifically server devices. Note that the tenant data service server 100, the data reception service server 140, and the service server 150 may be, for example, other information processing apparatuses, such as PCs, smartphones, and tablet terminals.

The data reception service server 140 is communicably connected to the tenant data service server 100, the control device 110, and the service server 150 via the network 170. The data reception service server 140 transmits printer information received from the control device 110 to the tenant data service server 100 and the service server 150.

The tenant data service server 100 is a server that manages the printer 130 and information on a user who uses a notification service. The notification service is a service that uses the server system to provide a function of notifying the client terminal 160 of printer information. The tenant data service server 100 performs account authentication for the user of the notification service and performs control to allow the client terminal 160 used by the authenticated user to receive the printer information. Also, the tenant data service server 100 stores the printer information received from the data reception service server 140.

The service server 150 has functions of a service application 151 and a push notification service 152, and the service server 150 is communicably connected to the tenant data service server 100, the control device 110, the data reception service server 140, and the client terminal 160 via the network 170.

The service application 151 is an application program that operates on the service server 150 and that functions to notify the client terminal 160 of events occurring in the printer 130 and to manage terminal information of the client (user) and notification events of the printer 130.

The service application 151 determines whether to issue an event notification based on the printer information received from the data reception service server 140 and on information of the print job. If the service application 151 determines to issue an event notification, the service application 151 notifies the client terminal 160 via the push notification service 152. Also, the service application 151 returns (transmits) a notification event of the printer 130 managed by the service application 151 in response to a request for obtaining printer information received from the service application 161 operating on the client terminal 160. Note that the service application 151 may obtain printer information from the tenant data service server 100 and return it together with the aforementioned notification event of the printer.

The push notification service 152 cooperates with a push notification server provided by a company that develops the operating system (OS) of the client terminal 160, and starts an application of the client terminal 160 with a push notification to display a message. For example, if the OS of the client terminal 160 is iOS® provided by APPLE Inc., the push notification server may be a server for the Apple Push Notification service (APNs), which is a service supported by iOS. If the OS of the client terminal 160 is Android® provided by Google LLC, the push notification server may be a server for the Firebase Cloud Messaging (FCM), which is a service supported by Android.

The client terminal 160 is, for example, a terminal device, such as a smartphone. Note that the client terminal 160 may also be another device, such as a PC or a tablet terminal, connectable to a network and capable of executing application programs.

The service application 161 is an application program that operates on the client terminal 160 and that can use the notification service by communicating with the service application 151 via a network. To use the service application 161, login processing (user authentication) using account information registered in advance in the tenant data service server 100 is required. The login processing may include, for example, inputting account information, authentication, and obtaining authentication information. For example, OAuth authentication may be used in the login processing.

The network 170 is, for example, a local area network (LAN), the Internet, or an intranet, and the network 170 may be a wired or wireless network.

### Hardware configuration of control device and servers

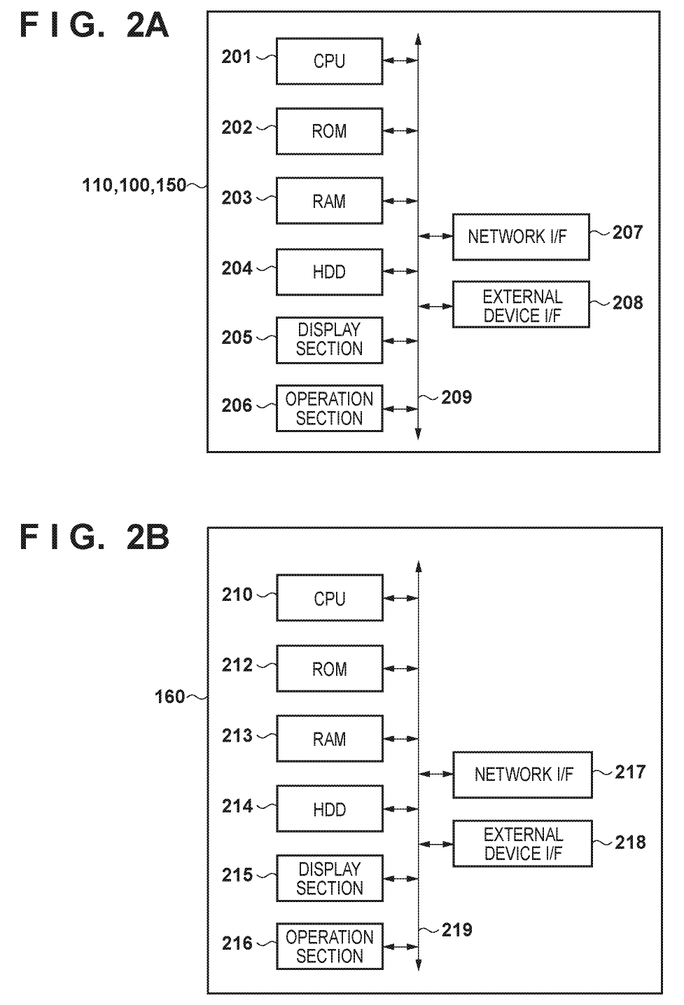

FIG. 2A is a block diagram showing an example of a hardware configuration of the control device 110. Note that the tenant data service server 100, the data reception service server 140, and the service server 150 also have the same hardware configuration described below.

The control device 110 includes a CPU 201, a ROM 202, a RAM 203, an HDD 204, a display section 205, an operation section 206, a network I/F 207, and an external device I/F 208. The components 201 to 208 shown in FIG. 2A are connected to each other via a system bus 209.

The CPU 201 is a computing device that includes at least one processor and controls the entire apparatus. In one example, the following processing performed by an information processing apparatus, such as the control device 110, is implemented by the CPU 201 executing programs stored in the ROM 202. Note that hardware dedicated to each type of processing may be prepared. And note that “CPU” stands for “Central Processing Unit”.

The ROM 202 is a non-volatile memory that stores, for example, various programs executed by the CPU 201, such as a boot program, processing programs including a control program, and an embedded OS program, as well as character data and character code information. Note that “ROM” stands for “Read Only Memory”.

The RAM 203 is a volatile memory constituted by, for example, a static random access memory (SRAM). The RAM 203 is used as a work memory when the CPU 201 executes various programs. The RAM 203 is used as a data storage area for various data, such as data of program control variables, management data of the information processing apparatus, and image files received via the network interface (I/F) 207. Note that “RAM” stands for “Random Access Memory”.

The hard disk drive (HDD) 204 is a storage device used to store, for example, the results of calculations performed by the CPU 201, the OS, system software, application software, various programs, and information files.

The display section 205 is constituted by, for example, a light emitting diode (LED) display or a liquid crystal display (LCD). The display section 205 displays a user interface (UI) screen to display various settings and data and to issue device state notifications.

The operation section 206 is constituted by a keyboard, a pointing device, or the like. The operation section 206 is used by the user to, for example, input various set values and to perform resets. Note that the display section 205 and the operation section 206 may be integrated by using an operational display section constituted by a touch panel or the like.

The network I/F 207 is an interface for connecting the apparatus to the network 170. The control device 110 transmits various types of information to and receives various types of information from external devices via the network I/F 207.

The external device I/F 208 is, for example, an interface for connecting the control device 110 and an external device via a communication bus, such as a Universal Serial Bus (USB).

### Hardware configuration of client terminal

FIG. 2B is a block diagram showing an example of a hardware configuration of the client terminal 160. The client terminal 160 includes a CPU 210, a ROM 212, a RAM 213, an HDD 214, a display section 215, an operation section 216, a network I/F 217, and an external device I/F 218. The components 210 to 218 shown in FIG. 2B are connected to each other via a system bus 219.

The CPU 210 is a computing device that includes at least one processor and controls the entire apparatus. The following processing performed by the client terminal 160 is implemented by the CPU 210 executing programs stored in the ROM 212 in one example. Note that hardware dedicated to each type of processing may be prepared.

The ROM 212 is a non-volatile memory that stores, for example, various programs executed by the CPU 210, such as a boot program, processing programs including a control program, and an embedded OS program, as well as character data and character code information.

The RAM 213 is a volatile memory constituted by a static random access memory (SRAM) or the like. The RAM 213 is used as a work memory when the CPU 210 executes various programs. The RAM 213 is used as a data storage area for various data, such as data of program control variables, management data of the information processing apparatus, and image files received via the network I/F 217.

The HDD 214 is a storage device used to store, for example, the results of calculations performed by the CPU 210, the operating system, system software, application software, and various programs and information files.

The display section 215 is constituted by, for example, a light emitting diode (LED) display or a liquid crystal display (LCD). The display section 215 displays a user interface (UI) screen to display various settings and data and to issue device state notifications.

The operation section 216 is constituted by a keyboard, a pointing device, or the like. The operation section 216 is used by the user to, for example, input various set values and to perform resets. Note that the display section 215 and the operation section 216 may be integrated by using an operational display section constituted by a touch panel or the like.

The network I/F 217 is an interface for connecting the client terminal 160 to the network 170. The client terminal 160 transmits various types of information to and receives various types of information from external devices via the network I/F 217.

The external device I/F 218 is, for example, an interface for connecting the client terminal 160 and an external device via a communication bus, such as a Universal Serial Bus (USB).

### Hardware configuration of printer

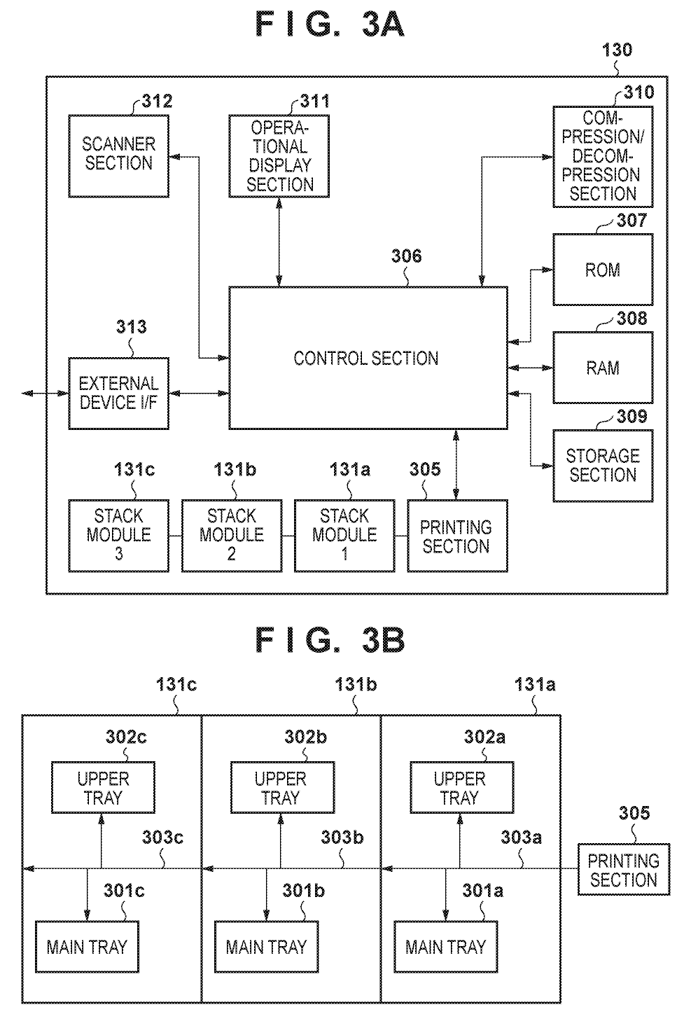

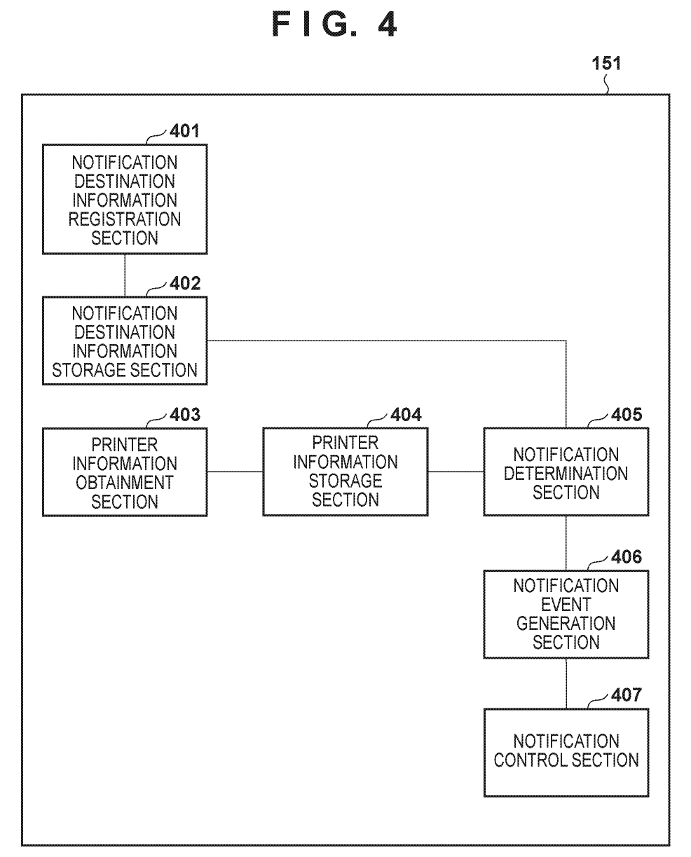

FIG. 3A is a block diagram showing an example of a hardware configuration of the printer 130. The printer 130 includes the stack modules 131a to 131c, the printing section 305, a control section 306, a ROM 307, a RAM 308, a storage section 309, a compression/decompression section 310, an operational display section 311, a scanner section 312, and an external device I/F 313.

The stack modules 131a to 131c are discharge devices for discharging, from the printer 130, printouts printed by the printing section 305. The configuration of the stack modules 131a to 131c will be described later with reference to FIG. 3B. Although the stack modules 131a to 131c in this example are provided on the main body of the printer 130, the present disclosure is not limited to this. The stack modules 131a to 131c may also be provided outside the printer 130.

The control section 306 is, for example, a CPU, and is a computing device that includes at least one processor and controls the entire apparatus. The following processing executed by the printer 130 is implemented by the control section 306 executing programs stored in the ROM 307. For example, when the control section 306 obtains a print job to be processed via other components, such as the scanner section 312 and the external device I/F 313, the control section 306 causes the printing section 305 to execute printing based on the obtained print job. Also, the control section 306 transmits various types of information to external devices, such as the control device 110, via the external device I/F 313. The control section 306 controls discharge operations using the stack modules 131a to 131c, for example. For example, the control section 306 may control the stack modules 131a to 131c so that printouts are discharged to a discharge destination designated by the print job. Further, for example, the control section 306 may control the stack modules 131a to 131c so as to change the discharge destination of printouts when the discharge destination of printouts becomes full.

The ROM 307 is a read only memory storing various programs. The ROM 307 also stores, for example, a program for interpreting and processing print jobs received from an external device, such as the control device 110, via the external device I/F 313.

The RAM 308 is a non-volatile memory that stores, for example, various programs executed by the control section 306, such as a boot program, processing programs including a control program, and an embedded OS program, as well as character data and character code information.

The storage section 309 is, for example, a memory, such as an HDD, and stores, for example, data of print jobs to be processed and various types of management information managed by the printer 130. The storage section 309 is also a large-capacity storage device that stores image data compressed by the compression/decompression section 310. The storage section 309 is capable of holding a plurality of data including print data of print jobs to be processed.

The compression/decompression section 310 performs compression and decompression operations on image data or the like stored in a memory, such as the RAM 308 or the storage section 309, using any of various compression methods, such as JBIG and JPEG.

The operational display section 311 includes a touch panel display and is capable of receiving user operations such as activating various functions and configuring various settings of the printer 130. Further, the operational display section 311 may also include, for example, physical operation keys, such as a character input key, a cursor key, a decision key, and a cancel key, as well as an LED and an LCD. Note that the printer 130 may also have an operation section and a display section separately.

The scanner section 312 can read originals, for example. Image data as the result of reading is stored in a memory, such as the ROM 307 or the storage section 309.

The external device I/F 313 communicates data with external devices. For example, the external device I/F 313 controls transmission and reception of various data, such as image data, to and from a facsimile, a network-connected device, or an external device (not shown) via the network 170 or another network. Also, the printer 130 uses the external device I/F 313 to transmit printer information or the like to the control device 110 via the network 170 or another network.

FIG. 3B is a block diagram showing an example of a hardware configuration of the stack modules 131a to 131c. The stack module 131a includes a main tray 301a and an upper tray 302a that are discharge trays for discharging printouts. Similarly, the stack module 131b includes a main tray 301b and an upper tray 302b. Similarly, the stack module 131c also includes a main tray 301c and an upper tray 302c. Note that the stack modules 131a to 131c in this example each have two discharge trays as shown in FIG. 3B, but the present disclosure is not limited to this configuration. For example, each of the stack modules 131a to 131c may include one discharge tray or more than two discharge trays.

The main tray 301a is a discharge tray with a carriage on which printouts can be loaded. The carriage can be drawn out of the main body of the stack module 131a to take out the printouts that have been printed by the printer 130. Similarly, the main tray 301b is a discharge tray with a carriage on which printouts can be loaded, and the carriage can be drawn out of the main body of the stack module 131b to take out the printouts that have been printed by the printer 130. Similarly, the main tray 301c is a discharge tray with a carriage on which printouts can be loaded, and the carriage can be drawn out of the main body of the stack module 131c to take out the printouts that have been printed by the printer 130.

The upper tray 302a is a discharge tray that is installed at an upper portion of the stack module 131a, and only printouts discharged onto the discharge tray can be taken out. Similarly, the upper tray 302b is a discharge tray that is installed at an upper portion of the stack module 131b, and only printouts discharged onto the discharge tray can be taken out. Similarly, the upper tray 302c is a discharge tray that is installed at an upper portion of the stack module 131c, and only printouts discharged onto the discharge tray can be taken out. Printouts printed by the printing section 305 are transported through paths 303a to 303c and discharged to the discharge tray designated by the print job.

Note that the number of printouts dischargeable to each discharge tray of the stack modules 131a to 131c is limited. The printer 130 has a function of counting the number of remaining printouts dischargeable to each discharge tray. For example, each of the stack modules 131a to 131c includes a detection section (not shown), such as a sensor, that detects printouts discharged to the discharge tray. The printer 130 obtains, for example, the detection result from the detection section (not shown) and counts the number of printouts dischargeable with each of the stack modules 131a to 131c. If the number of printouts discharged to the discharge tray exceeds a predetermined value (maximum number) based on the detection result, the printer 130 changes the discharge destination to a different discharge tray. That is, when the discharge tray has become full of the printouts discharged thereto, the printer 130 changes the discharge destination of printouts to a different discharge tray.

For example, when the main tray 301a has become full and there is no printout discharged to the upper tray 302a, the printer 130 changes the discharge destination from the main tray 301a to the upper tray 302a.

Further, for example, in the case where the plurality of stack modules 131a to 131c are joined to each other as shown in FIGS. 3A and 3B, the printer 130 may change the discharge destination to a main tray or an upper tray of a stack module where no discharged printout is present.

Further, for example, when discharged printouts are present but printouts to be discharged can be loaded on the already-present printouts, the printer 130 may change the discharge destination to the discharge tray on which printouts are already present.

When the printer 130 has changed the discharge destination of printouts, the printer 130 transmits to the control device 110 change information indicating that the discharge destination of printouts has been changed as event information. The control device 110 transmits printer information including this event information to the data reception service server 140.

The above-described discharge destination change function can also be disabled in the printer 130. For example, the control section 306 of the printer 130 may cause the operational display section 311 to display a setting screen (not shown) capable of receiving a user operation for enabling or disabling the discharge destination change function. The setting screen (not shown) can be displayed at any time after powering on the printer 130, for example. Based on a user operation received on the setting screen (not shown), the control section 306 enables or disables the function of changing the discharge destination of printouts. Note that the control device 110 may also receive the user operation for enabling or disabling the discharge destination change function.

The control device 110 generates an identifier for identifying each stack module and each discharge tray of the stack module (hereinafter referred to as a discharge destination identifier) in accordance with the number of joined stack modules. More specifically, for example, the control device 110 obtains printer information from the printer 130 in response to the control device 110 being powered on. Here, the printer information that the control device 110 obtains from the printer 130 includes information indicating the apparatus configuration of the printer 130. In the case where the printer 130 has stack modules, information indicating the apparatus configuration of the printer 130 includes, for example, information indicating the number of joined stack modules, information indicating a device name of each stack module, and information indicating the joining order of the stack modules. The control device 110 specifies the number of stack modules of the printer 130, the joining order, and the like, based on the printer information obtained from the printer 130. Then, the control device 110 assigns a unique identifier to each stack module according to the specified number of stack modules, and also assigns corresponding identifiers to discharge trays of each stack module. The control device 110 stores the generated discharge destination identifiers in a memory, such as the RAM 203 or the HDD 204, of the control device 110, for example.

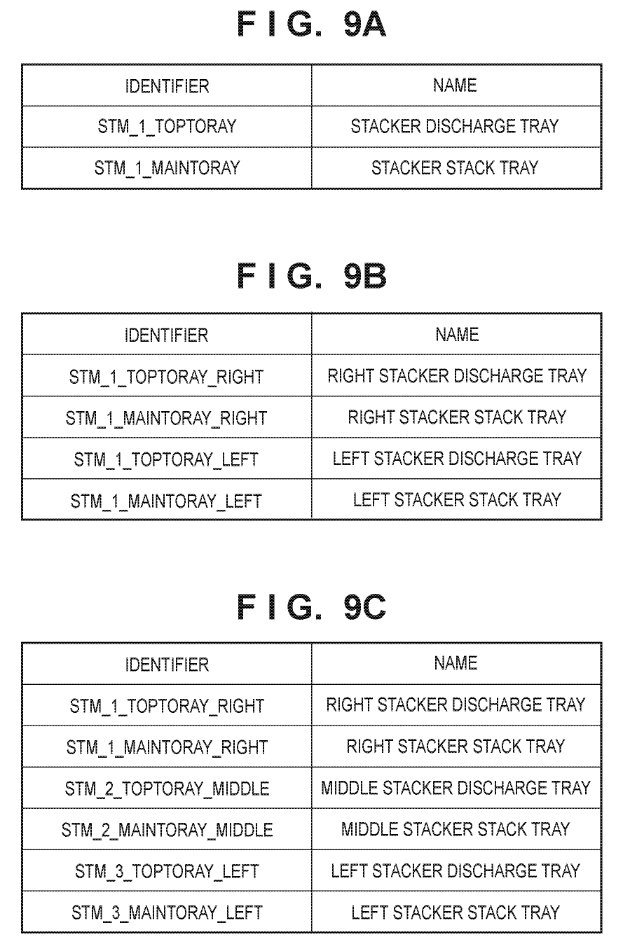

FIGS. 9A to 9C show examples of the identifiers and names of the stack modules and the discharge trays according to the number of stack modules. FIG. 9A shows examples of discharge destination identifiers and names corresponding to the respective discharge destination identifiers that are generated by the control device 110 in the case where the printer 130 has one stack module 131a. FIG. 9B shows examples of discharge destination identifiers and names corresponding to the respective discharge destination identifiers that are generated by the control device 110 in the case where the printer 130 has two stack modules 131a and 131b that are joined to each other. FIG. 9C shows examples of discharge destination identifiers and names corresponding to the respective discharge destination identifiers that are generated by the control device 110 in the case where the printer 130 has three stack modules 131a to 131c that are joined to each other.

As shown in FIGS. 9A to 9C, the control device 110 generates unique identifiers by assigning an integer suffix to each stack module in ascending order according to the number of stack modules of the printer 130. Also, the control device 110 assigns names “TOPTRAY” and “MAINTRAY” to the corresponding discharge trays of each stack module. For example, in the case where the printer 130 includes two stack modules, the control device 110 assigns an identifier including information indicating the positional relationship between the stack modules (e.g., “RIGHT” to a stack module located on the right side when seen from the operating user, and “LEFT” to a stack module located on the left side). In the case where three stack modules are provided, an identifier including “MIDDLE” is assigned to a stack module at the center.

When transmitting the printer information including event information to the data reception service server 140, the control device 110 includes the aforementioned discharge destination identifier in the printer information.

Note that in the present embodiment, the integer suffixes are assigned in the ascending order in the case where printouts are transported from the right to the left as viewed from the user operating the printer 130. However, the present disclosure is not limited to this. For example, the suffixes may be assigned in the reverse order in the case of a printer 130 in which printouts are transported from the left to the right. Further, in the case where four or more stack modules are provided, identifiers including information on the positional relationship are similarly assigned.

### Software configuration of service server

FIG. 4 is a block diagram showing an example of a software configuration of the service application 151 according to the present embodiment. The service application 151 includes a notification destination information registration section 401, a notification destination information storage section 402, a printer information obtainment section 403, a printer information storage section 404, a notification determination section 405, a notification event generation section 406, and a notification control section 407. These functional sections are implemented by the CPU 201 of the service server 150 loading the service application 151 stored in the ROM 202, which is a computer-readable memory, into the RAM 203 and executing the service application 151. The following describes each functional section.

The notification destination information registration section 401 performs settings and registration for specifying the client terminal 160 to be a notification destination. Specifically, the notification destination information registration section 401 receives identification information of the client terminal 160 required for push notification transmission, from the service application 161 operating on the client terminal 160, via an application programming interface (API). Then, the notification destination information registration section 410 stores the received identification information of the client terminal 160 as notification destination information in the notification destination information storage section 402. The identification information of the client terminal 160 is, for example, obtained from a push notification server provided by a company that develops the operating system (OS) of the client terminal 160.

The printer information obtainment section 403 receives printer information transmitted from the data reception service server 140. Further, based on the received printer information, the printer information obtainment section 403 obtains registration information on the printer 130 from the tenant data service server 100. The printer information obtainment section 403 stores the obtained printer registration information together with the printer information in the printer information storage section 404.

In response to the printer information obtainment section 403 obtaining the printer information, the notification determination section 405 determines whether to notify the client terminal 160 of the printer information. More specifically, the notification determination section 405 determines whether to notify the client terminal 160 based on the notification destination information stored in the notification destination information storage section 402 and the received printer information. For example, the notification determination section 405 determines to execute notification if information is detected from which the user can ascertain the operation state of the printer 130 (e.g., when the printer 130 starts printing from a standby state or when an error occurs during printing). Also, the notification determination section 405 determines whether to notify the client terminal 160 based on a notification permission setting included in user information.

If the notification determination section 405 determines to execute notification, the notification event generation section 406 generates notification information. The notification information is information for notifying the client terminal 160 of an event that has occurred in the printer 130. The notification information includes, for example, information indicating the operation state of the printer 130 and the stack modules 131a to 131c, information indicating the event that has occurred in the printer 130, an occurrence time, print job information, a title, text, and other elements of a notification message to be displayed on the client terminal 160.

When the printer information includes a discharge destination identifier as any of those shown in FIGS. 9A to 9C, the notification event generation section 406 generates a notification message using the name corresponding to the discharge destination identifier.

The notification control section 407 transmits the notification information generated by the notification event generation section 406 together with the identification information of the client terminal 160 to the push notification service 152.

In the present embodiment, an example is described in which the notification event generation section 406 generates a notification message using a name such as any of those shown in FIGS. 9A to 9C based on the discharge destination identifier generated by the control device 110. However, the present disclosure is not limited to this. For example, the control device 110 may transmit joining configuration information on the stack modules to the tenant data service server 100 in advance. The joining configuration information is information indicating the above-described apparatus configuration of the printer 130. The notification event generation section 406 may generate the discharge destination identifier based on registration information on the printer 130 including the joining configuration information on the stack modules obtained from the tenant data service server 100.

### Notification message display screen of client terminal

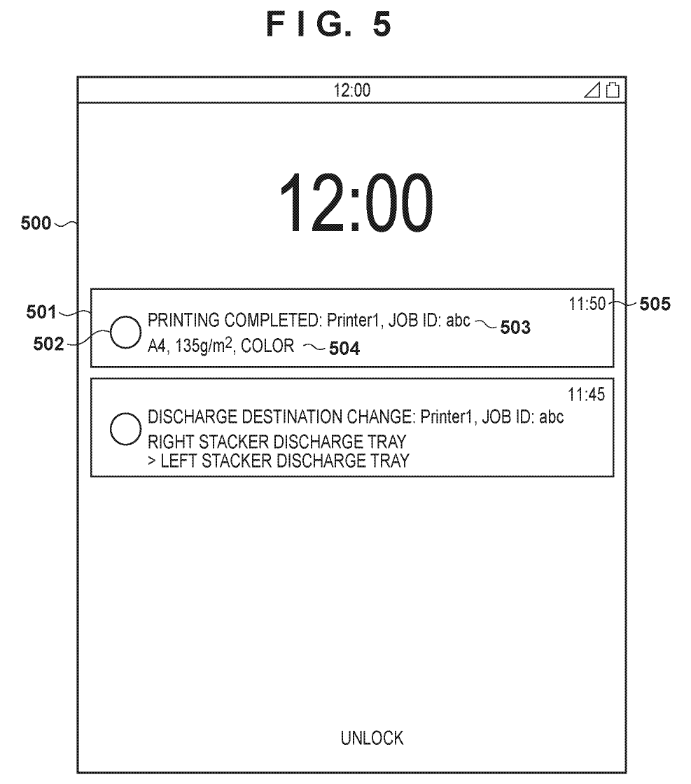

FIG. 5 is a diagram showing an example of an operation screen 500 displayed on the display section 215 by the OS of the client terminal 160. The OS of the client terminal 160 displays a notification message on the operation screen 500 based on notification information transmitted from the push notification service 152.

A notification message 501 includes an application icon 502, a title 503 of the notification message, a character string 504 of the text, and a notification time 505. The notification time 505 is the date and time when the notification information was received.

With such a notification message 501 displayed on the operation screen 500, the user can easily ascertain the time and details of the push notification. When the notification message 501 is selected by the user, the OS analyzes the notification information and starts the service application 161 registered on the push notification service.

In the example shown in FIG. 5, the notification message 501 indicates that the printer 130 has completed printing based on a print job with a job ID “abc”. The screen 500 in FIG. 5 also displays an example of a notification message indicating that the discharge destination of printouts has been changed from the upper tray 302a of the right stack module 131a to the upper tray 302c of the left stack module 131c while the printer 130 is executing the print job with the job ID “abc”.

### Screen displayed by service application

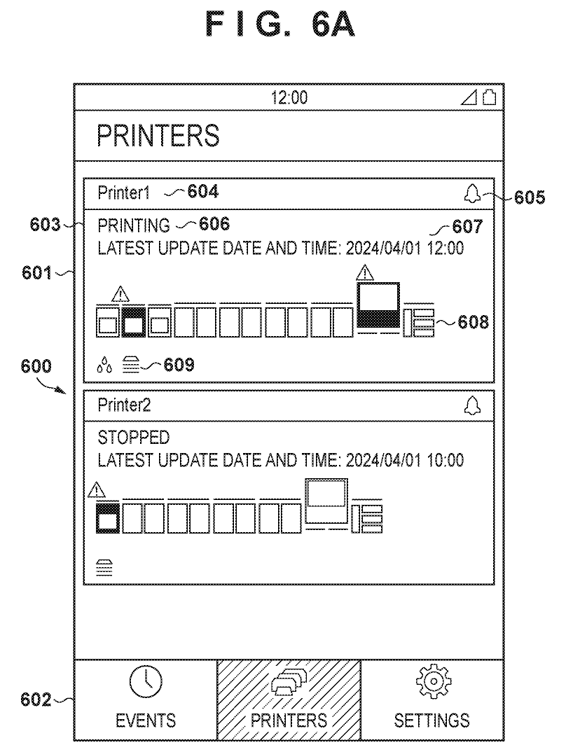

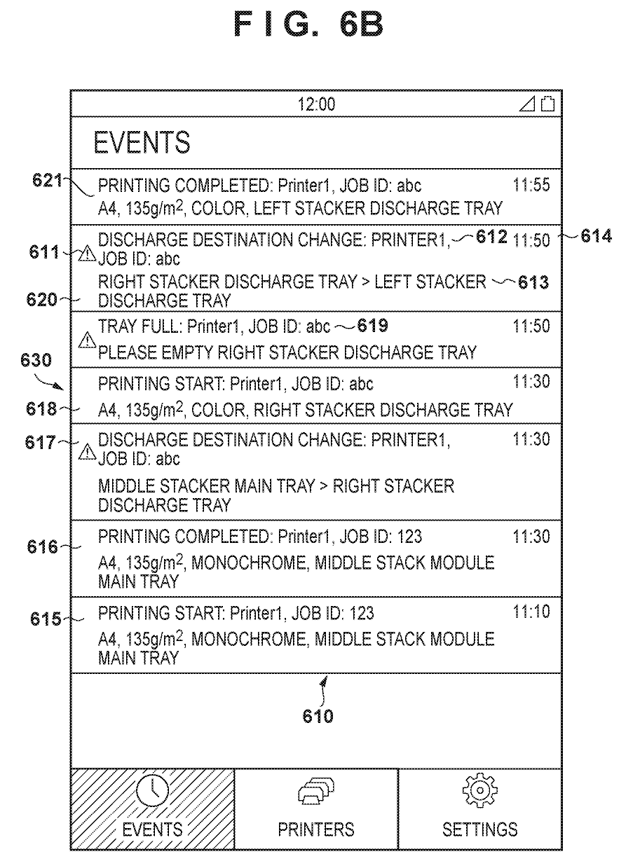

FIGS. 6A and 6B are diagrams showing examples of screens displayed on the display section 215 of the client terminal 160 by the service application 161 according to the present embodiment.

FIGS. 6A and 6B show screens for displaying various types of information regarding the printer 130. A screen 600 shown in FIG. 6A includes an area 601 for displaying various types of information regarding the printer 130 and includes an area 602 capable of receiving a user selection for switching the display content in the area 601. In the area 602, an item selected by the user is highlighted. FIG. 6A shows a screen 600 when “printer” is selected in the area 602, and FIG. 6B shows a screen 630 when “event” is selected in the area 602.

In the area 601, the states of printers 130 associated with a user account for the notification system are displayed in a list. The area 601 includes a display portion 603 for displaying the state of each printer 130.

The display portion 603 displays a printer name 604, a notification permission setting 605, information 606 indicating the operation state, a latest date and time 607 when the printer information was obtained, a printer icon 608, and a detailed status icon 609.

When the service application 161 is started or when “printer” is selected in the area 602, the service application 161 obtains printer information from the service server 150. In the case where more than one printer 130 is registered in the user account, the service application 161 displays the display portion 603 for each of the registered printers 130 in the area 601.

The notification permission setting 605 is an area for configuring various user settings related to push notifications related to the printer 130.

The printer icon 608 is an icon indicating the apparatus configuration of the printer 130. The service application 161 changes the display content of the printer icon 608 in accordance with the type of the printer 130 and the number of joined stack modules. When an error has occurred or a setting has been changed in any of the devices, such as the printer 130 and the stack modules 131a to 131c, the service application 161 displays only the device in which the error has occurred as the printer icon 608. That is, the service application 161 uses the printer icon 608 to highlight the apparatus in which an error has occurred. This allows the user to recognize the error location.

The detailed status icon 609 is an icon indicating the state of consumables in the printer 130 and the state of each device, such as a discharge tray. By displaying the detailed status icon 609, the user can be notified of, for example, paper jams or a decrease in the remaining amount of consumables in the printer 130.

FIG. 6B shows a screen 630 for issuing notifications of events that have occurred in the printer 130. In the area 601, the notification content indicating notification information associated with the user account for the notification system is displayed in a list in the order of date and time of occurrence. Specifically, a notification display portion 610 that displays the notification content of each item of notification information obtained by the service application 161 is displayed in the area 601. When the service application 161 is started or when “event” is selected in the area 602, the service application 161 obtains notification information from the service server 150.

The notification content displayed in the notification display portion 610 includes, for example, a notification event icon 611, a title 612 of the notification information that is a notification message, a character string 613 of the text of the notification information, and a notification time 614. Depending on the type of the notification event, the content of the notification event icon 611 may be changed and need not necessarily be displayed.

The screen 630 shown in FIG. 6B shows an example of the notification content when the print job is switched in the printer 130 and when the stack module of the discharge destination has been changed during printing. The service application 161 displays the following notification messages based on the notification information generated by the service server 150.

A notification message 615 includes a message indicating that the printer 130 has started printing based on the print job with the job ID “123” and includes a message indicating that the discharge destination of printouts is the main tray 301b of the stack module 131b arranged at the center.

A notification message 616 includes a message indicating that the printer 130 has ended printing based on the print job with the job ID “123” and includes a message indicating that the discharge destination of printouts is the main tray 301b of the stack module 131b arranged at the center.

A notification message 617 includes a message indicating that the discharge destination of printouts has been changed based on the switching of the print job from the job ID “123” to a job ID “abc” in the printer 130. Also, the notification message 617 includes a message indicating that the discharge destination before the change is the main tray 301b of the stack module 131b arranged at the center and indicating that the discharge destination after the change is the upper tray 302a of the stack module 131a arranged on the right side.

A notification message 618 includes a message indicating that the printer 130 has started printing based on the print job with the job ID “abc” and includes a message indicating that the discharge destination of printouts is the upper tray 302a of the stack module 131a arranged on the right side.

A notification message 619 includes a message indicating that the upper tray 302a of the stack module 131a arranged on the right side is full of printouts while the printer 130 is executing printing based on the print job with the job ID “abc”. The notification message 619 includes a message prompting the user to empty the upper tray 302a of the right stack module 131a.

The notification message 620 includes a message indicating that the discharge destination of printouts has been changed while the printer 130 is executing the print job with the job ID “abc”. Also, the notification message 620 includes a message indicating that the discharge destination before the change is the upper tray 302b of the right stack module 131b and indicating that the discharge destination after the change is the upper tray 302c of the left stack module 131c.

A notification message 621 includes a message indicating that the printer 130 has ended printing based on the print job with the job ID “abc” and includes a message indicating that the discharge destination of printouts is the upper tray 302c of the left stack module 131c.

By displaying such notification messages 615 to 621 on the notification display portion 610, the user can ascertain the events that have occurred in the printer 130. For example, even if the discharge destination of printouts is changed in the printer 130, the user is notified of the discharge destination after the change by messages such as the notification messages 617 and 620, and can thereby recognize the discharge destination after the change.

Further, the location of the stack module that is the discharge destination after the change is indicated, for example, as the right stack module 131a or the left stack module 131c. Thus, even when the plurality of stack modules 131a to 131c are joined to the printer 130, the user can easily specify the arrangement location of the stack module that is the discharge destination after the change.

### Example processing performed in notification system

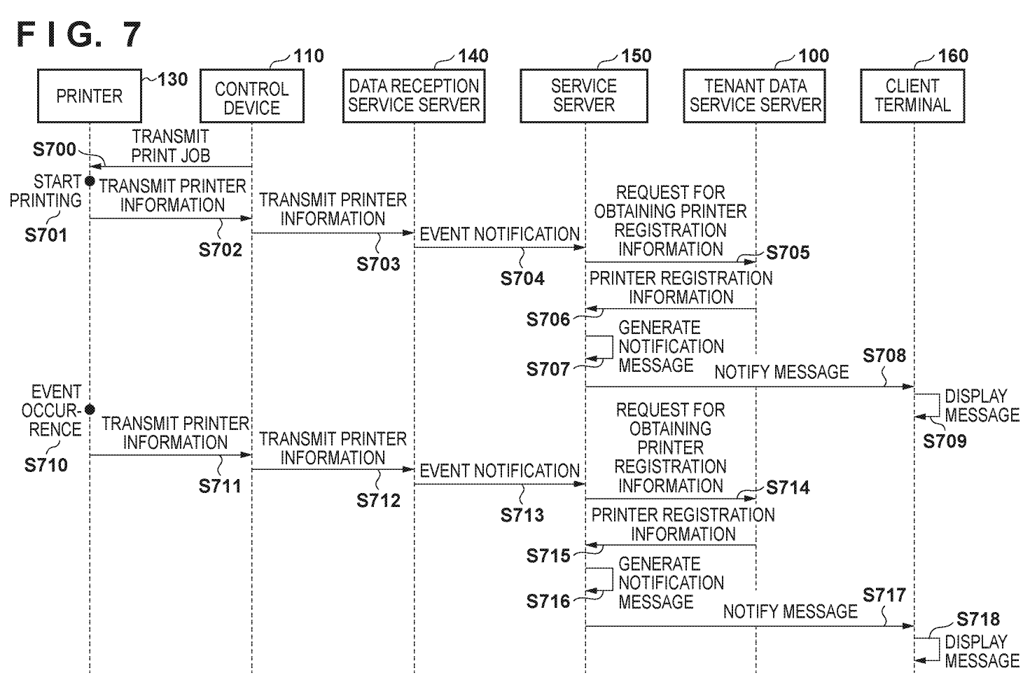

FIG. 7 is a sequence diagram illustrating example processing performed in the notification system according to the present embodiment. The following is a description of an example of processing performed when the printer 130 starts printing based on a print job and changes the discharge destination during printing. The processing performed by each apparatus in this sequence is implemented by a CPU included in the apparatus loading various programs stored in a memory, such as a ROM included in the apparatus, into a RAM and executing the programs. Note that the present embodiment is based on the premise that the function of changing the discharge destination of printouts is enabled in the printer 130.

In step S700, the control device 110 transmits a print job to the printer 130.

In step S701, the printer 130 receives the print job transmitted from the control device 110 in step S700, and the printer 130 starts printing on a print medium with the printing section 305 based on the received print job. That is, in step S701, an event of starting printing occurs in the printer 130.

In step S702, the printer 130 transmits printer information to the control device 110. The printer information includes event information. Here, the event information includes, for example, information indicating that the printer 130 has started printing, information indicating the print job for which the printer 130 has started printing, and information indicating the discharge destination of printouts.

In step S703, the control device 110 receives the printer information transmitted from the printer 130 in step S702, then the control device 110 includes the aforementioned discharge destination identifier in the received printer information and transmits this printer information to the data reception service server 140.

In step S704, the data reception service server 140 notifies the service server 150 that an event has occurred in the printer 130. Specifically, the data reception service server 140 transmits the printer information received from the control device 110 to the service server 150.

In step S705, based on the printer information being received from the data reception service server 140, the service server 150 requests the tenant data service server 100 for registration information on the printer 130 associated with the received printer information. The registration information on the printer 130 is, for example, a notification permission setting for the service application 161 that is configured on the printer 130.

In step S706, the tenant data service server 100 transmits the registration information on the printer 130 to the service server 150. The service server 150 determines whether to notify the service application 161, based on the registration information on the printer 130 received from the tenant data service server 100. Specifically, if the received notification permission setting is “permitted”, the service server 150 determines to notify the service application 161 of the printer information. On the other hand, if the received notification permission setting is “not permitted,” the service server 150 determines not to notify the service application 161 of the printer information. In the following description of the present embodiment, it is assumed that the notification permission setting of the printer 130 is “permitted”.

In step S707, the service server 150 generates notification information (a notification message) for issuing a notification of the event that has occurred in the printer 130, based on the printer information transmitted from the data reception service server 140. Specifically, in step S707, the service server 150 generates notification information for issuing a notification that the printer 130 has started printing. The notification information includes, for example, a message indicating that the printer 130 has started printing, a message indicating a print job started by the printer 130, and a message indicating the name of the discharge destination of printouts. More specifically, for example, the service server 150 generates the name of the discharge destination of printouts corresponding to the discharge destination identifier, based on the discharge destination identifier included in the printer information.

In step S708, the service server 150 transmits, to the client terminal 160, the generated notification information via the push notification service 152 and a push notification server provided by a company that develops the OS of the client terminal 160.

In step S709, the client terminal 160 displays the notification message on the display section 215 as shown in the example screen of FIG. 5, based on the received notification information. Thereafter, the client terminal 160 receives a user operation for starting the service application 161. When receiving the user operation, the client terminal 160 starts the service application 161 and displays a similar notification message as an event list shown in FIG. 6B with the service application 161.

The following describes processing in steps S710 to S718 with a focus on differences from steps S701 to S709. The processing in steps S710 to S718 is executed each time an event occurs in the printer 130.

In step S710, for example, the printer 130 changes the discharge destination of printouts to a different discharge tray based on the maximum number of printouts dischargeable to the discharge destination having been reached (i.e., the discharge tray becoming full of printouts) during execution of printing based on the print job started in step S701. That is, in step S710, an event of changing the discharge destination of printouts occurs in the printer 130.

In step S711, the printer 130 transmits printer information to the control device 110. The printer information includes event information. Here, the event information includes change information indicating that the discharge destination of printouts has been changed based on the maximum number of printouts dischargeable to the discharge destination having been reached in the printer 130. The change information includes, for example, information indicating the discharge destination of printouts before the change, information indicating the discharge destination of printouts after the change, and information indicating a print job being executed by the printer 130.

Processing in steps S712 to S715 is performed in the same manner as in steps S703 to S706, and the description thereof is omitted accordingly.

In step S716, the service server 150 generates notification information for issuing a notification of the event that has occurred in the printer 130, based on the printer information transmitted from the data reception service server 140. Specifically, in step S716, the service server 150 generates notification information (a notification message) for issuing a notification that the printer 130 has changed the discharge destination of printouts. The notification information includes, for example, a message indicating that the printer 130 has changed the discharge destination of printouts, a message indicating names of the discharge destinations before and after the change, and a message indicating a print job being executed by the printer 130. The message indicating the names of the discharge destinations before and after the change can also be referred to as discharge destination information indicating the discharge destinations before and after the change. Based on the discharge destination identifiers included in the printer information, the service server 150 generates notification information including the name indicating the discharge destination before the change and the name indicating the discharge destination after the change corresponding to the discharge destination identifiers of the stack modules, such as those shown in FIGS. 9A to 9C.

Specifically, in step S716, the service server 150 generates the above-described notification information based on the change information included in the printer information. The following describes an example of the notification information generated by the service server 150 based on the content of the change information.

For example, a description is given of discharge destination information that is generated when the change information indicates that the discharge destination before the change is the upper tray 302a of the stack module 131a and that the discharge destination after the change is the upper tray 302c of the stack module 131c. That is, the following describes an example of discharge destination information when the discharge destination of printouts is changed between different stack modules. In such a case, the service server 150 generates, as the discharge destination information, information indicating that the discharge destination of printouts has been changed from the upper tray 302a of the stack module 131a to the upper tray 302c of the stack module 131c.

Also, for example, a description is given of discharge destination information in the case where the change information indicates that the discharge destination before the change is the main tray 301a of the stack module 131a and that the discharge destination after the change is the upper tray 302a of the stack module 131a. That is, an example is described in which the discharge destination of printouts is changed between different discharge trays provided in the same stack module. In such a case, the service server 150 generates, as the discharge destination information, information indicating that the discharge destination of printouts has been changed from the main tray 301a of the stack module 131a to the upper tray 302a of the stack module 131a.

Step S717 is performed in the same manner as step S708, and the description thereof is omitted accordingly.

In step S718, the client terminal 160 displays the notification message on the display section 215 as shown in the example screen of FIG. 5, based on the notification information received in step S717. Thereafter, the client terminal 160 receives a user operation for starting the service application 161. When receiving the user operation, the client terminal 160 starts the service application 161 and displays similar notification messages as an event list shown in FIG. 6B with the service application 161.

### Example processing performed when printing ends in printer

Note that, in step S710 described above, an example has been described in which an event of changing the discharge destination of printouts occurs in the printer 130. However, the present disclosure is not limited to this. For example, there may be a case where, in step S710, the printer 130 may end printing based on the completion of execution of the print job. That is, there may be a case where, in step S710, an event of an end of printing may occur in the printer 130.

In such a case of an end of printing, in step S711, the printer 130 transmits printer information including event information to the control device 110. The event information includes, for example, information indicating that the printer 130 has ended printing, information indicating the print job for which the printer 130 has ended printing, and information indicating the discharge destination of printouts.

Further, in such a case of an end of printing, in step S716, the service server 150 generates notification information (notification message) for issuing a notification of the event that has occurred in the printer 130, based on the printer information transmitted from the data reception service server 140. Specifically, in step S716, the service server 150 generates notification information (notification message) for issuing a notification that the printer 130 has ended printing. The notification information includes, for example, a message indicating that the printer 130 has ended printing, a message indicating a print job ended by the printer 130, and a message indicating the name of the discharge destination of printouts. More specifically, for example, the service server 100 generates the name of the discharge destination of printouts corresponding to the discharge destination identifier, based on the discharge destination identifier included in the printer information.

### Change of discharge destination due to switching of print job

In step S710 in the above-described example, the printer 130 changes the discharge destination of printouts to a different discharge tray based on the maximum number of printouts dischargeable to the discharge destination having been reached during printing based on the print job started in step S701. However, the present disclosure is not limited to this. For example, there may be a case where, in step S710, the printer 130 changes the discharge destination of printouts based on a switching of the print job. More specifically, after ending first printing based on a first print job, the printer 130 continuously starts second printing based on the next print job. In such a case, for example, the printer 130 changes the discharge destination of printouts from a first discharge destination designated by the first print job to a second discharge destination designated by the second print job. That is, in step S710, an event of changing the discharge destination of printouts occurs in the printer 130.

In such a case, in step S711, the printer 130 transmits printer information including event information to the control device 110. Here, the event information includes change information indicating that the printer 130 has changed the discharge destination based on the switching of the print job. The change information includes, for example, information indicating the first discharge destination of printouts before the change, information indicating the second discharge destination of printouts after the change, and information indicating the second print job being executed by the printer 130.

Further, in such a case, in step S716, the service server 150 generates notification information (a notification message) for issuing a notification of the event that has occurred in the printer 130, based on the printer information transmitted from the data reception service server 140. Specifically, in step S716, the service server 150 generates notification information (a notification message) for issuing a notification that the printer 130 has changed the discharge destination of printouts based on the switching of the print job. The notification information includes, for example, a message indicating that the printer 130 has changed the discharge destination, a message indicating the second print job being executed by the printer 130, and a message indicating the name of the discharge destination of printouts according to the second print job.

As described above, according to the present embodiment, the server system receives information regarding an event that has occurred in the printer 130 from the printing system. The server system generates notification information for issuing a notification of the event that has occurred in the printer 130. The server system transmits the generated notification information to the client terminal 160. If the event that has occurred in the printer is a change of the discharge destination of printouts, the server system generates notification information indicating that the discharge destination of printouts has been changed in the printer 130. This notification information includes information indicating the discharge destination after the change. The server system transmits the generated notification information to the client terminal 160. Such processing allows the user to easily ascertain the discharge destination of printouts from the client terminal even when the printing apparatus has changed the discharge destination of printouts.

### Second Embodiment

The second embodiment will be described below regarding differences from the first embodiment. In the notification system in the first embodiment, when the printer 130 having a plurality of discharge destinations changes the discharge destination of printouts, notification information indicating that the discharge destination has been changed is transmitted to the client terminal 160.

There may be cases where the discharge destination change function is disabled in the printer 130. For example, when the user has not configured a setting for using the discharge destination change function on the printer 130, the discharge destination change function is disabled. In such a case, the user cannot use the discharge destination change function when, for example, the discharge destination becomes full in the printer 130. In the present embodiment, if the discharge destination change function is disabled when a discharge tray becomes full of printouts, the server system transmits notification information indicating that the discharge destination change function is available to the client terminal 160.

### Screen displayed by service application

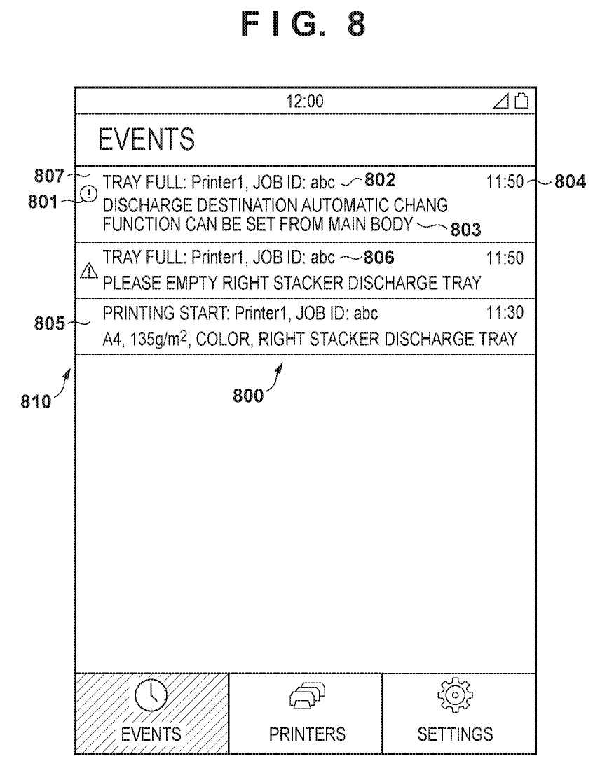

FIG. 8 shows an example of a screen 810 displayed on the display section 215 of the client terminal 160 by the service application 161 according to the present embodiment. FIG. 8 shows the screen 810 for issuing a notification of events that have occurred in the printer 130, similar to FIG. 6B. The notification content displayed in a notification display portion 800 includes, for example, a notification event icon 801, a title 802 of a notification event that is a notification message, a character string 803 of the text of the notification event, and a notification time 804. Notification messages 805 to 806 are the same as the notification messages 618 to 619.

A notification message 807 includes a message indicating that the discharge destination is full of printouts while the printer 130 is executing printing based on the print job with the job ID “abc”. The notification message 807 also includes a message indicating that the change function can be enabled in the printer 130. Note that the notification messages 806 and 807 may be displayed together.

With such a notification message 807, when the discharge destination is full of printouts in the printer 130, the user can recognize that the discharge destination change function is available even if the discharge destination change function is disabled.

### Example processing performed in notification system

A description will be given of example processing performed by the notification system when the discharge destination change function is disabled in the printer 130, with reference to FIG. 7. Processing in steps S700 to S709 is the same as in the first embodiment, and the description thereof is omitted accordingly.

In step S710, for example, the printer 130 detects that the maximum number of printouts dischargeable to the discharge destination has been reached during printing based on the print job started in step S701. That is, in step S710, an event of the discharge destination of printouts becoming full in the printer 130 occurs.

In step S711, the printer 130 transmits printer information to the control device 110. The printer information includes event information. Here, the event information includes error information indicating that the maximum number of printouts dischargeable to the discharge destination has been reached in the printer 103 (i.e., information indicating that the discharge destination is full). The error information includes, for example, information indicating the discharge destination that is full, information indicating the print job being executed by the printer 130, and information indicating that the function for changing the discharge destination of printouts printed by the printer 130 (i.e., discharge destination change function) is disabled.

Processing in steps S712 to S715 is performed in the same manner as in steps S703 to S706, and the description thereof is omitted accordingly.

In step S716, the service server 150 generates notification information for issuing a notification of the event that has occurred in the printer 130, based on the printer information transmitted from the data reception service server 140. Specifically, in step S716, the service server 150 generates notification information (notification messages) for issuing a notification that the discharge destination of printouts is full. The notification information includes, for example, a message indicating that the discharge destination is full, a message prompting the user to empty the full discharge destination, a message for notifying the user that the discharge destination change function can be enabled, a message indicating the name of the full discharge destination, and a message indicating the print job being executed by the printer 130.

Step S717 is performed in the same manner as in step S708, and the description thereof is omitted accordingly.

In step S718, the client terminal 160 displays the notification messages on the display section 215 as shown in the example screen of FIG. 5, based on the notification information received in step S717. Thereafter, the client terminal 160 receives a user operation for starting the service application 161. Upon receiving the user operation, the client terminal 160 starts the service application 161 and displays a similar notification message as an event list shown in FIG. 8 with the service application 161.

Note that the present embodiment has described an example in which the service server 150 notifies the client terminal 160 of a message prompting the user to empty a discharge tray, and a message that the discharge destination change function is available at the same time. However, the present disclosure is not limited to this. For example, the service server 150 may notify the client terminal 160 of a message that the discharge destination change function is available after notifying the client terminal 160 of a message prompting the user to empty a discharge tray.

Furthermore, the present embodiment may adopt a configuration in which the notification content received by the service server 150 from the data reception service server in step S713 does not include information indicating that the discharge destination change function is disabled. For example, the printer registration information that the service server 150 obtains from the tenant data service server 100 in step S715 may also include information indicating that the discharge destination change function is disabled.

As described above, according to the present embodiment, it is possible to notify the user that the discharge destination change function is available when the discharge destination of printouts is full in the printer 130, even if the discharge destination change function is disabled.

According to the present disclosure, it is possible to provide a technology that improves user convenience when the discharge destination of printouts is changed.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-020989, which was filed on February 12, 2025 and which is hereby incorporated by reference herein in its entirety.

What is claimed is:

1. An information processing system comprising:
at least one memory; and
at least one processor, wherein the at least one memory and the at least one processor are configured to:
receive event information related to an event that has occurred in a printing apparatus; and
output notification information for issuing a notification of the event that has occurred in the printing apparatus, based on the event information,
wherein if the event information includes change information indicating a change of a discharge destination of printouts printed by the printing apparatus, the notification information includes discharge destination information indicating the discharge destination after the change.

2. The information processing system according to claim 1, wherein the at least one memory and the at least one processor are further configured to output information indicating that the discharge destination of the printouts has been changed from a first tray to a second tray as the discharge destination information.

3. The information processing system according to claim 1, wherein the at least one memory and the at least one processor are further configured to output information indicating that the discharge destination of the printouts has been changed from a first discharge device to a second discharge device as the discharge destination information.

4. The information processing system according to claim 3, wherein the at least one memory and the at least one processor are further configured to, if the change information further includes an identifier indicating a positional relationship between the first discharge device and the second discharge device, output the notification information further including information indicating the positional relationship between the first discharge device and the second discharge device, based on the identifier.

5. The information processing system according to claim 3,
wherein, in a case where the at least one memory and the at least one processor receive configuration information indicating a configuration of the printing apparatus, the at least one memory and the at least one processor output an identifier indicating a positional relationship between the first discharge device and the second discharge device based on the configuration information and output the notification information further including information indicating the positional relationship between the first discharge device and the second discharge device based on the identifier.

6. The information processing system according to claim 1, wherein the at least one memory and the at least one processor are further configured to, in a case where the change information is information indicating that the discharge destination of the printouts has been changed from a first discharge destination to a second discharge destination based on the number of printouts discharged to the first discharge destination exceeding a predetermined value while the printing apparatus is executing printing, output information indicating that the discharge destination of the printouts has been changed from the first discharge destination to the second discharge destination as the discharge destination information.

7. The information processing system according to claim 1, wherein the at least one memory and the at least one processor are further configured to, in a case where the change information is information indicating that the discharge destination of the printouts has been changed based on the printing apparatus switching from a first print job to a second print job, output information indicating the discharge destination of the printouts for the second print job as the discharge destination information.

8. The information processing system according to claim 1, wherein the at least one memory and the at least one processor are further configured to, in a case where the event information includes information indicating that a function for changing the discharge destination of the printouts printed by the printing apparatus is disabled, output the notification information including information indicating that it is possible to enable the function in the printing apparatus.

9. The information processing system according to claim 1, wherein the information processing system is a server.

10. The information processing system according to claim 1,
wherein the at least one memory and the at least one processor are further configured to transmit, as output of the notification information, the notification information such that the notification information is received by a terminal device capable of displaying a notification based on the notification information.

11. The information processing system according to claim 10,
wherein the at least one memory and the at least one processor are further configured to transmit the notification information to a server system that sends a push notification to the terminal device.

12. The information processing system according to claim 1, further comprising:
a printing system including a transmission unit configured to transmit the event information related to the event that has occurred in the printing apparatus.

13. A method comprising:
receiving event information related to an event that has occurred in a printing apparatus; and
outputting notification information for issuing a notification of the event that has occurred in the printing apparatus, based on the event information;
wherein if the event information includes change information indicating a change of a discharge destination of printouts printed by the printing apparatus, during the outputting, the notification information includes discharge destination information indicating the discharge destination after the change.

14. A non-transitory computer-readable storage medium storing instructions that, when executed by a computer of an information processing system, cause the information processing system to:
receive event information related to an event that has occurred in a printing apparatus; and
output notification information for issuing a notification of the event that has occurred in the printing apparatus, based on the event information;
wherein if the event information includes change information indicating a change of a discharge destination of printouts printed by the printing apparatus, the notification information includes discharge destination information indicating the discharge destination after the change.
